(19) United States
(12) Patent Application Publication
(10) Pub. No.: US 2008/0264221 A1
(43) Pub. Date: Oct. 30, 2008

(54) WORK SHEET PROCESSING SYSTEM

(75) Inventor: Daisuke KATSUYAMA, Inuyama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA MACHINERY, LTD., Kyoto-shi (JP)

(21) Appl. No.: 12/104,828

(22) Filed: Apr. 17, 2008

(30) Foreign Application Priority Data
Apr. 25, 2007 (JP) 2007-115160

(51) Int. Cl. B26D 7/32

(52) U.S. Cl. 83/151; 83/167

(57) ABSTRACT

The present invention provides a work sheet processing system that can compactly collect a plurality of product work sheets cut by a work sheet processing machine, allowing the product work sheets to be easily transported to a next process. A work sheet processing system includes a work sheet processing machine 1 that cuts a plurality of product work sheets from a material work sheet W0, a work sheet collecting vehicle 3 on which the product work sheets cut by the work sheet processing machine are loaded, and a work sheet carry-out device 2 that carries out the product work sheets from the work sheet processing machine 1 to the work sheet collecting vehicle 3. The work sheet collecting vehicle 3 has a planar placing portion 32 on which the product work sheets are loaded so as to be laid on top of one another like a stack, and a leaning-against portion 31 on which the product work sheets are loaded so as to lean against the leaning-against portion 31. The work sheet carry-out device 2 has a travelable traveling member 13, a product holder 20 which is provided on the traveling member 13, a tilting mechanism that can tilt the product holder 20 according to an angle of the leaning-against portion 31, and a conveyance control device that controls the traveling member 13, product holder 20, and tilting mechanism such that the product work sheets are sorted and loaded on the planar placing portion 32 or leaning-against portion 31 of the work sheet collecting vehicle 3 according to type of the product work sheets.

### FIELD OF THE INVENTION

The present invention relates to a work sheet processing system that cuts a plurality of product work sheets from a material work sheet, processes the product work sheets, and then loads the product work sheets on a vehicle that transports the product work sheets to a next process.

### BACKGROUND OF THE INVENTION

Some products such as automatic vending machines and office furniture are assembled from a plurality of work sheets. Work sheet processing machines, for example, punch presses, can produce all or almost all of the work sheets constituting these products by performing various processing operations such as punching, shape forming, and cutting. In the conventional art, various product work sheets produced by the work sheet processing machine are loaded on a vehicle so as to be stacked flat. The vehicle then transports the product work sheets to a next process. The following methods are available for loading the product work sheets on the vehicle: (1) only the same type of product work sheets are collectively loaded on the vehicle, (2) the product work sheets are divided into groups corresponding to processes used, and for each of the processes, the corresponding group is loaded on the vehicle, or (3) a set of product work sheets used to assemble a final product is collectively loaded on the vehicle.

In the case (1), in a site to which the product work sheets are transported, the product work sheets need to be sorted according to the processes or final products. The sorting operation is cumbersome. Thus, the method (2) or the method (3) is desirable in terms of working efficiency. With the method (2) or the method (3), plural types of product work sheets are loaded on one vehicle. In this case, product work sheets of different sizes need to be loaded on the vehicle so as to be stacked. A work sheet loading device that can perform this operation has thus been proposed (for example, the Unexamined Japanese Patent Application Publication (Tokkai) No. 2004-123276).

However, where the product work sheets are stacked flat on the vehicle as in the conventional art, large-sized product work sheets are disadvantageously difficult to transport to a post-process because the large-size product work sheets have large front-back lengths and lateral lengths. Furthermore, where the product work sheets are stacked flat, the product work sheets processed earlier are placed lower on the vehicle. Thus, where the product work sheets are transported by the method (2) or the method (3), the lower product work sheets must be taken out from the plural groups of product work sheets laid on top of one another like a stack. With large-sized product work sheets, this taking-out operation is very difficult to achieve.

### SUMMARY OF THE INVENTION

An object of the present invention is to provide a work sheet processing system that can compactly collect a plurality of product work sheets cut by a work sheet processing machine, on a vehicle, allowing the product work sheets to be easily transported to a next process. Another object of the present invention is to improve the efficiency of processing or assembly in the subsequent process. Yet another object of the present invention is to make it possible to efficiently sort and load many types of product work sheets on the vehicle and to load small-sized product work sheets on the vehicle without distributing the product work sheets.

A work sheet processing system according to the present invention comprises a work sheet processing machine that cuts a plurality of product work sheets from a material work sheet, a work sheet collecting vehicle on which the product work sheets cut by the work sheet processing machine are loaded, and a work sheet carry-out device that carries out the product work sheets from the work sheet processing machine to the work sheet collecting vehicle, the work sheet collecting vehicle having a planar placing portion on which the product work sheets are loaded so as to be laid on top of one another like a stack, and a leaning-against portion on which the product work sheets are loaded so as to lean against the leaning-against portion, the work sheet carry-out device having a traveling member that is travelable along a predetermined track, a product holder which is provided on the traveling member and which can hold the product work sheets, a tilting mechanism that can tilt the product holder according to an angle of the leaning-against portion of the work sheet collecting vehicle, and a conveyance control device that controls the traveling member, the product holder, and the tilting mechanism such that the product work sheets on the work sheet processing machine are sorted and loaded on the planar placing portion or the leaning-against portion of the work sheet collecting vehicle according to type of the product work sheets.

According to the configuration of this work sheet processing system, the work sheet carry-out device the product work sheets on the work sheet processing machine to the work sheet collecting vehicle. The work sheet carry-out device uses the product holder to hold the product work sheets on the work sheet processing machine. The work sheet carry-out device then allows the traveling member to travel along the track from the position of the work sheet processing machine to the position of the work sheet collecting vehicle with the product work sheets remaining held by the product holder. At the position of the work sheet collecting vehicle, the work sheet carry-out device cancels the holding of the product work sheets by the product holder. Thus, the product work sheets are loaded on the planar placing portion or the leaning-against portion of the work sheet collecting vehicle. Where the product work sheets are loaded on the leaning-against portion, the holding of the product work sheets is canceled with the product holder tilted according to the angle of the leaning-against portion. Thus tilting the product holder allows the product work sheets to be appropriately loaded on the leaning-against portion. The product work sheets are sorted and loaded on the planar placing portion or the leaning-against portion according to the type of each product work sheet. Consequently, plural types of product work sheets can be compactly loaded on the work sheet collecting vehicle. For example, by loading large-sized product work sheets so that the product work sheets lean against the leaning-against portion, it is possible to reduce the front-back length or lateral length of the work sheet collecting vehicle with the product work sheets loaded thereon. Thus, transportation to the next process can be easily achieved. Furthermore, where the product work sheets are loaded so as to lean against the leaning-against portion, any of the plurality of product work sheets can be easily taken out even though the product work sheets are large in size. Thus, even if product work sheets to be used earlier in the next process are loaded earlier for convenience of processing by the work sheet processing machine or the like, the product work sheets loaded earlier can be easily taken out.

Where the work sheet processing machine processes a set of product work sheets used to assemble a final product, the set of product work sheets may be loaded on the work sheet collecting vehicle. Loading the set of product work sheets on the work sheet collecting vehicle eliminates the need for the time and effort to sort the product work sheets during the subsequent process. This improves the efficiency of processing or assembly in the subsequent process.

Furthermore, desirably, the work sheet collecting vehicle has a drawer type product housing portion that can be moved in and out between a storage position where the product housing portion is stored inside the work sheet collecting vehicle and a draw-out position where the product housing portion is drawn out from the work sheet collecting vehicle, and the work sheet carry-out device performs an operation of housing the product work sheets in the drawer type product housing portion located at the draw-out position. The provision of the drawer type product housing portion allows many types of product work sheets to be sorted and loaded. In particular, small-sized product work sheets can be loaded without being distributed. Since the work sheet carry-out device also houses the product work sheets in the drawer type product housing portion, the product work sheets can be efficiently housed in the drawer type product housing portion.

The work sheet processing system according to the present invention comprises the work sheet processing machine that cuts the plurality of product work sheets from the material work sheet, the work sheet collecting vehicle on which the product work sheets cut by the work sheet processing machine are loaded, and the work sheet carry-out device that carries out the product work sheets from the work sheet processing machine to the work sheet collecting vehicle, the work sheet collecting vehicle having the planar placing portion on which the product work sheets are loaded so as to be laid on top of one another like a stack, and the leaning-against portion on which the product work sheets are loaded so as to lean against the leaning-against portion, the work sheet carry-out device having the traveling member that is travelable along a predetermined track, a product holder which is provided on the traveling member and which can hold the product work sheets, a tilting mechanism that can tilt the product holder according to an angle of the leaning-against portion or the work sheet collecting vehicle, and the conveyance control device that controls the traveling member, product holder, and tilting mechanism such that the product work sheets on the work sheet processing machine are sorted and loaded on the planar placing portion or leaning-against portion of the work sheet collecting vehicle according to type of the product work sheets. Thus, the plurality of product work sheets cut by the work sheet processing machine can be compactly collected and easily transported to the next process.

Where the work sheet processing machine processes the set of product work sheets used to assemble the final product, the set of product work sheets are loaded on the work sheet collecting vehicle. This improves the efficiency of processing or assembly in the subsequent process.

Where the work sheet collecting vehicle has the drawer type product housing portion that can be moved in and out between the storage position where the product housing portion is stored inside the work sheet collecting vehicle and the draw-out position where the product housing portion is drawn out from the work sheet collecting vehicle, and the work sheet carry-out device performs the operation of housing the product work sheets in the drawer type product housing portion located at the draw-out position, many types of product work sheets can be efficiently sorted and loaded on the work sheet collecting vehicle. Furthermore, small-sized product work sheets can be loaded without being distributed.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view of a work sheet processing system according to an embodiment of the present system.

FIG. 2 is a perspective view of a work sheet collecting vehicle in the work sheet processing system.

FIG. 3 is a perspective view showing that product work sheets are loaded on the work sheet collecting vehicle.

FIG. 4 is a side view of an essential part of a work sheet carry-out device in the work sheet processing system.

FIG. 5 is a diagram illustrating the operation of the work sheet carry-out device.

FIGS. 6A to 6C are plan views of a product holder of the work sheet carry-out device, showing that different product work sheets are held.

FIG. 7 is a block diagram showing the conceptual configuration of a conveyance control device of the work sheet carry-out device.

FIG. 8 is a block diagram showing the conceptual configuration of the conveyance control device.

FIG. 9 is a perspective view of a different work sheet collecting vehicle.

### DETAILED DESCRIPTION OF THE PREFERRED EMBODIMENTS

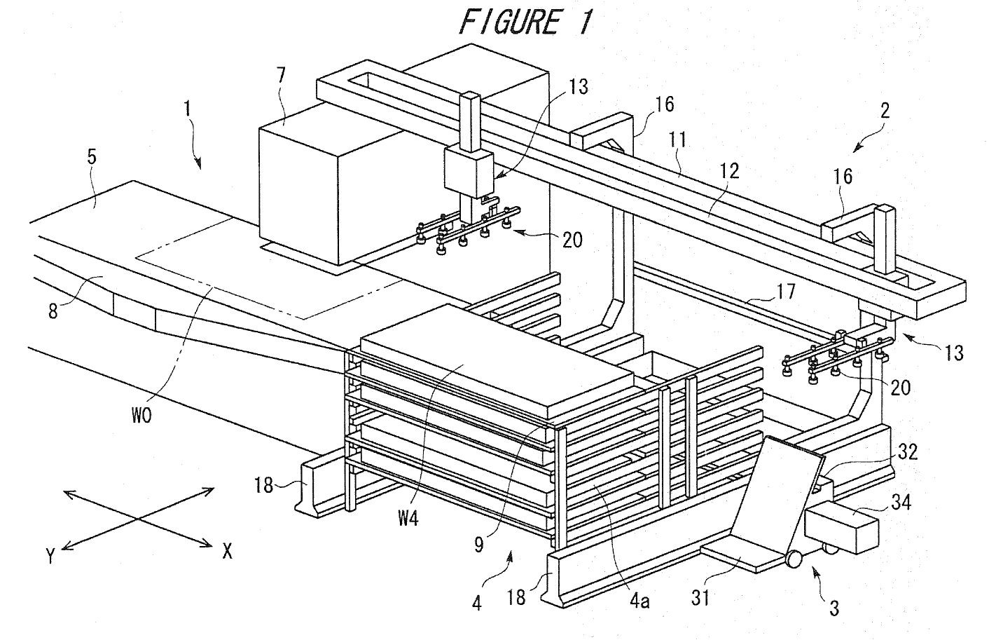

An embodiment of the present invention will be described with reference to FIGS. 1 to 8. FIG. 1 is a perspective view of an entire work sheet processing system. The work sheet processing system comprises a work sheet processing machine 1, a work sheet carry-out device 2, a work sheet collecting vehicle 3, and a work sheet stocker 4. The work sheet processing system further comprises a work sheet carry-in device that carries in material work sheet W0 into the work sheet processing machine 1. The description of the work sheet carry-in device is omitted.

The work sheet processing machine 1 comprises a function of cutting a plurality of product work sheets from the material work sheet W0 on a table 5 by means of punching or the like. The work sheet processing machine 1 is composed of a punch press, a laser processor, or the like. In this example, the work sheet processing machine 1 is a punch press, and comprises a processing portion 7 that elevates and lowers a punch tool (not shown in the drawings) with respect to a die tool (not shown in the drawings) for processing, and a work sheet feeding mechanism 8 that moves the material work sheet W0 on the table 5 forward and backward (Y direction) and rightward and leftward (X direction).

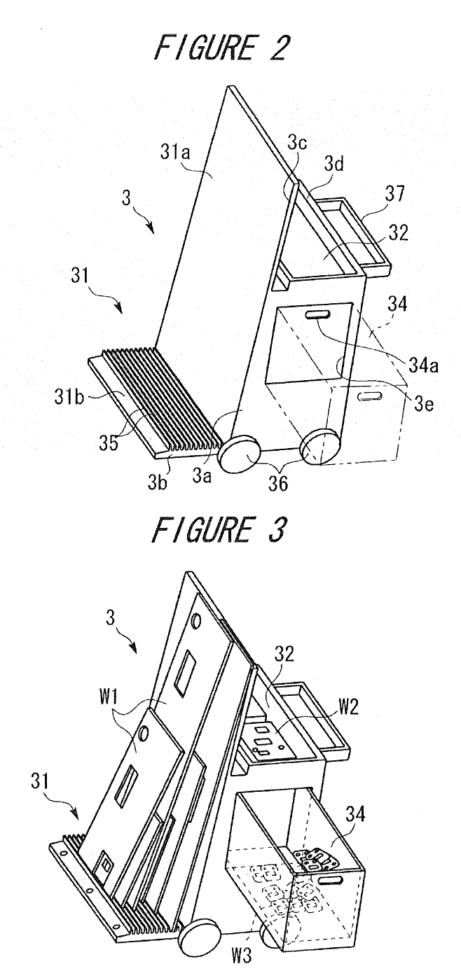

The work sheet collecting vehicle 3 is a vehicle on which transports product work sheets processed by the work sheet processing machine 1 and carried out by the work sheet carry-out device 2, to a next process. FIG. 2 shows that no product work sheet is loaded on the work sheet collecting vehicle 3. FIG. 3 shows that product work sheets have been loaded on the work sheet collecting vehicle 3. The work sheet collecting vehicle 3 has a leaning-against portion 31 located in the front thereof and on which the product work sheets are stacked so as to lean against a leaning-against surface 31a, a planar placing portion 32 on which the product work sheets are loaded so as to be laid on top of one another like a stack, and a drawer type product housing portion 34 that can be drawn out in a lateral direction; both the planar placing portion 32 and the drawer type product housing portion 34 are arranged in the back of the work sheet collecting vehicle 3. The planar placing portion 32 is recessed so as to be open upward. The drawer type product housing portion 34 is positioned below the planar placing portion 32. Specifically, the work sheet collecting vehicle 3 has a vehicle main body 3a with a front surface constituting the leaning-against surface 31a, a plate-like work sheet placement surface forming portion 3b projecting frontward from a lower end of the front surface of the vehicle main body 3a, and a plate-like leaning-against surface forming portion 3c projecting upward from an upper end of the front surface. A top surface of the work sheet placement surface forming portion 3b constitutes the work sheet placement surface 31b of the leaning-against surface 31. A plurality of lateral grooves 35 are formed in the work sheet placement surface 31b. Front surfaces of the vehicle main body 3a and the leaning-against surface forming portion 3c constitute the leaning-against surface 31a. A surrounding wall 3d is protrusively formed on four sides of a top surface portion of the vehicle main body 3a like a recess. This recessed portion constitutes the planar placing portion 32. Furthermore, the drawer type product housing portion 34 can be freely moved into and out from the vehicle main body 3a through an opening 3e formed in a side surface of the vehicle main body 3a, so as to change between a state in which the drawer type product housing portion 34 is wholly stored in the vehicle main body 3a and a state in which the drawer type product housing portion 34 is drawn out from the vehicle main body 3a. The drawer type product housing portion 34 has a hand placing hole 34a in which an operator places the hand in order to draw out the drawer type product housing portion 34. The work sheet collecting vehicle 3 comprises four casters 36 at the bottom of the vehicle main body 3a. The work sheet collecting vehicle 3 is thus manually moved by the operator by grabbing a handle 37 provided on a rear surface portion of the vehicle main body 3a. In FIG. 3, large-sized product work sheets W1 are loaded on the leaning-against portion 31. Medium-sized product work sheets W2 are loaded on the planar placing portion 32. Small-sized product work sheets W3 are loaded in the drawer type product housing portion 34. The product work sheets W1 are leaned against the leaning-against surface 31a by engaging lower ends of the product work sheets W1 with the grooves 35, formed in the work sheet placement surface 31b of the leaning-against portion 31. This prevents the product work sheets from being displaced.

The product work sheets W3, shown by solid lines in FIG. 3, have been released from the product holder 20 of the work sheet carry-out device 2, described below, and then fallen into the drawer type product housing portion 34.

As shown in FIG. 1, the work sheet stocker 4 is a device that places product work sheets W4, that is, particularly large-sized ones of the product work sheets processed by the work sheet processing machine 1, on palettes 9 like a stack. The work sheet stocker 4 has a shelf 4a with multiple stages on which the palettes 9 are placed. The palette 9 in any stage of the shelf 4a of the work sheet stocker 4 can be moved forward and backward between an illustrated front storage position and a product carry-in position to which the palette 9 is moved from the storage position in the Y direction.

The work sheet carry-out device 2 is a device that carries out the product work sheets W1 to W4 processed by the work sheet processing machine 1, to the work sheet collecting vehicle 3 or to the palettes 9 in the work sheet stocker 4. The work sheet carry-out device 2 comprises two tracks 11 installed parallel to each other between the work sheet processing machine 1 and a stop position of the work sheet collecting vehicle 3 and facing in the lateral direction, two traveling members 13 that are independently travelable along the tracks 11, and product holders 20 provided on the respective traveling members 13.

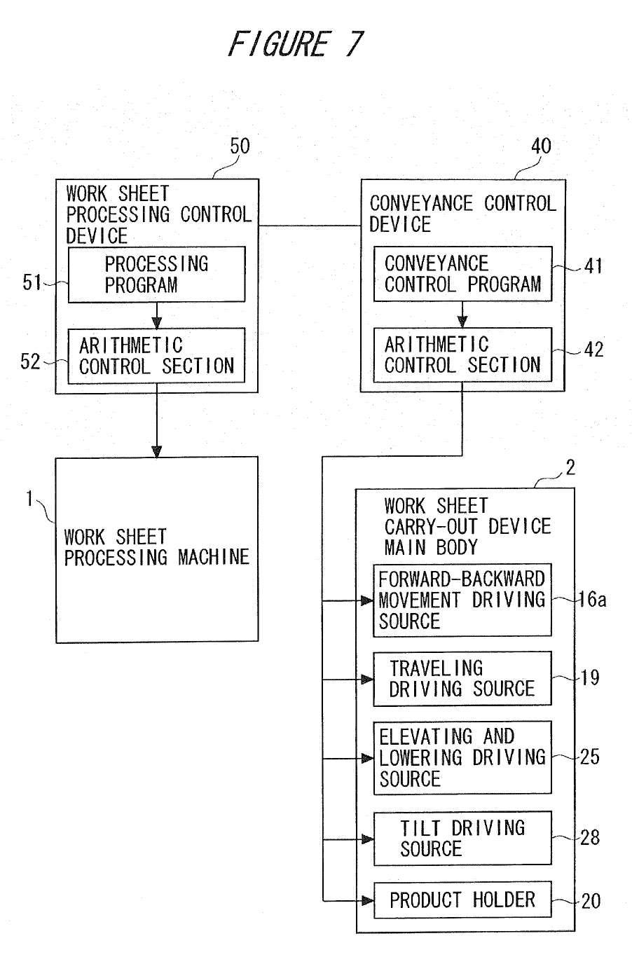

The two tracks 11 are integrally coupled together at the opposite ends thereof. The tracks 11 are supported by a lateral pair of forward-backward moving frames 16. The front-back moving frames 16 each have an upper end fixed to the rear track 11 and are coupled together via a horizontal frame 16. The lateral pair of frontward-backward moving frames 16 is movable along forward-backward moving rails 18 and can be moved forward and backward by a forward-backward movement driving source 16a (FIG. 7). The forward-backward movement driving source 16a is composed of, for example, a servo motor and a transformation mechanism such as a ball screw which transforms rotation of the servo motor into a linear operation.

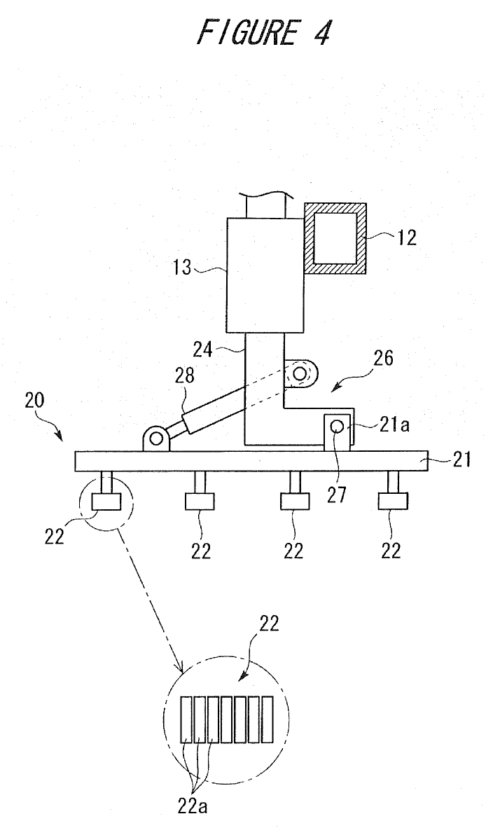

FIG. 4 is a side view of the traveling member 13 and the product holder 20. The figure shows the traveling member 13 traveling along the front track 11. The traveling member 13 traveling along the front track 11 is slightly partly different from that traveling along the rear track 11. However, both traveling members 13 have basically the same configuration. Each of the traveling members 13 is provided on the track 11 so as to be travelable via a guide member (not shown in the drawings). The traveling member 13 is self-propelled by a traveling driving source 19 (FIG. 7) such as a servo motor. The guide member is, for example, a linear roller bearing or a guide roller and is interposed between the traveling member 13 and the track 11.

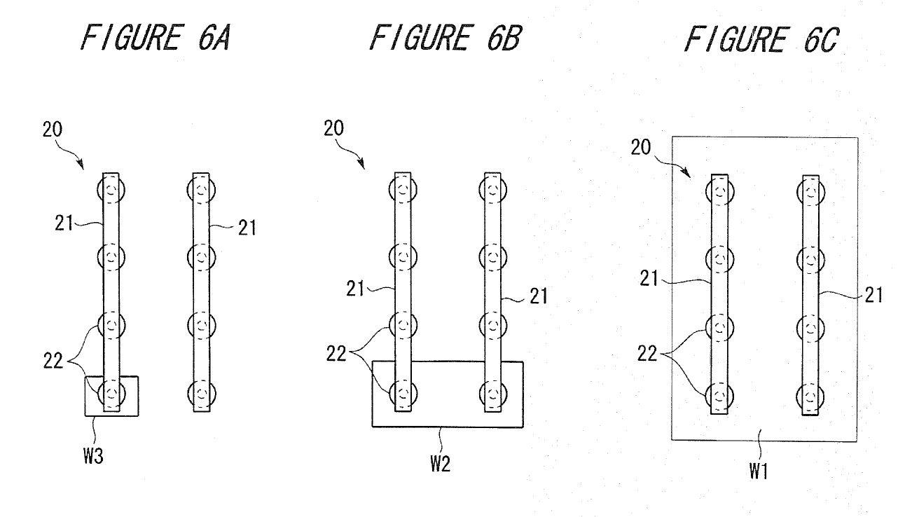

The product holder 20 is composed of a pad support frame 21 extending in the forward-backward direction and a plurality of suction pads 22 attached to the pad support frame 21. In this embodiment, the two pad support frames 21 are provided on the right and left sides, respectively, of the product holder 20. Four suction pads 22 are attached to each of the pad support frames 21. The product holder 20 thus comprises a total of eight suction pads 22. For example, the small-sized product work sheet W3 is sucked and held using one suction pad 22 as shown in FIG. 6A. The medium-sized product work sheet W2 is sucked and held using a plurality of suction pads 22 as shown in FIG. 6B. The large-sized product work sheet W1 is sucked and held using all the suction pads 22 as shown in FIG. 6C. As shown in FIGS. 6A and 6B, when the small-sized product work sheet W3 or the medium-sized product work sheet W2 is sucked and held, the suction pads 22 in the frontmost row are preferably used. Furthermore, the suction pad 22 closer to the work sheet processing machine 1 is preferably used. This is because the use of the suction pads 22 located at the above-described positions makes it possible to easily prevent the product holder 20 from interfering with the work sheet processing machine 1. Furthermore, the particularly large-sized product work sheet W4 is held by using the two product holders 20 through the cooperation between the two traveling members 13 (this is not shown in the drawings).

As shown in the partly enlarged view in FIG. 4, in the present embodiment, the suction pad 22 is composed of a bundle of a plurality of unit suction pads 22a individually connected to a vacuum source via a throttled path.

Even though some of the unit suction pads 22a are out of contact with a suction target such as any of the product work sheets W1 to W4, the suction pad 22 can suck the product work sheet. The suction pad 22 as a whole may constitute a single negative pressure portion instead of being formed into a bundle as described above.

The product holder 20 can be elevated and lowered with respect to the traveling member 13. In the present embodiment, a vertically long elevating and lowering member 24 is fitted into the traveling member 13. The pad support frame 21 is attached to a lower end of the elevating and lowering member 24. An elevating and lowering driving source 25 (FIG. 7) elevates and lowers the elevating and lowering member 24. The elevating and lowering driving source 25 may be provided separately from the traveling member 13 or the traveling member 13 itself may be the elevating and lowering driving source. The elevating and lowering member 24 of the traveling member 13 traveling along the front track 11 has a backward bent lower end.

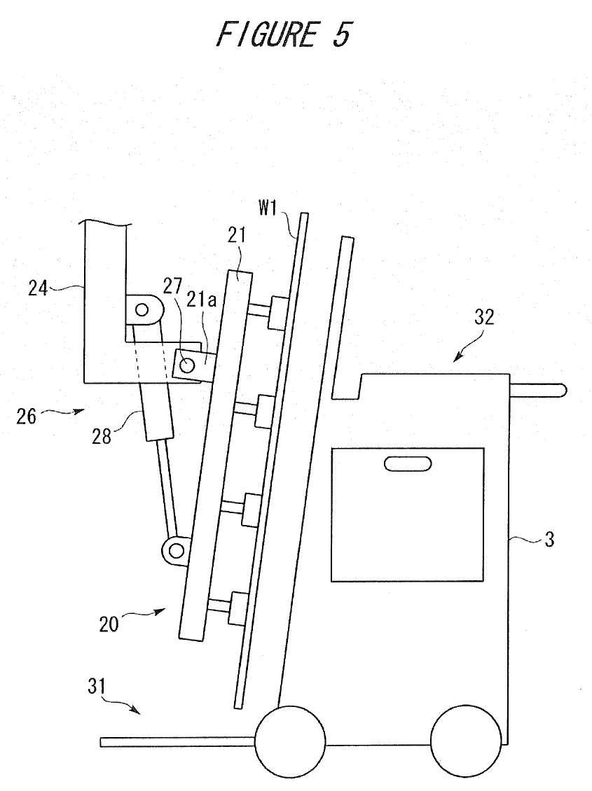

As shown in FIG. 5, the product holder 20 can be tilted by a tilting mechanism 26 at an angle corresponding to the leaning-against portion 31 of the work sheet collecting vehicle 3. The tilting mechanism 26 pivotably couples the lower end of the elevating and lowering member 24 to a projecting piece 21a provided on a top surface of the pad support frame 21, via a pivoting support point shaft 27. The tilting mechanism 26 uses a tilt driving source 28 such as a fluid cylinder to tilt the product holder 20 such that a front side of the product holder 20 faces downward.

With reference to FIG. 7, a description will be given of a conveyance control device that controls the work sheet carry-out device 2. The conveyance control device 40 is composed of a computerized numerical control device and a program controller and comprises a conveyance control program 41 and an arithmetic control section 42 that executes the conveyance control program 41. The arithmetic control section 42 includes a central processing unit and a memory, as well as a programmable controller.

The arithmetic control section 42 of the conveyance control device 40 issues an output instruction to the driving sources for the work sheet carry-put device 2. The driving sources include the forward-backward movement driving source 16a for the forward-backward moving frame 16, the traveling driving source 19 for the traveling member 13, the elevating and lowering driving source 25 for the product holder 20, the tilt driving source 28 for the product holder 20, and (a suction driving source for) the product holder 20.

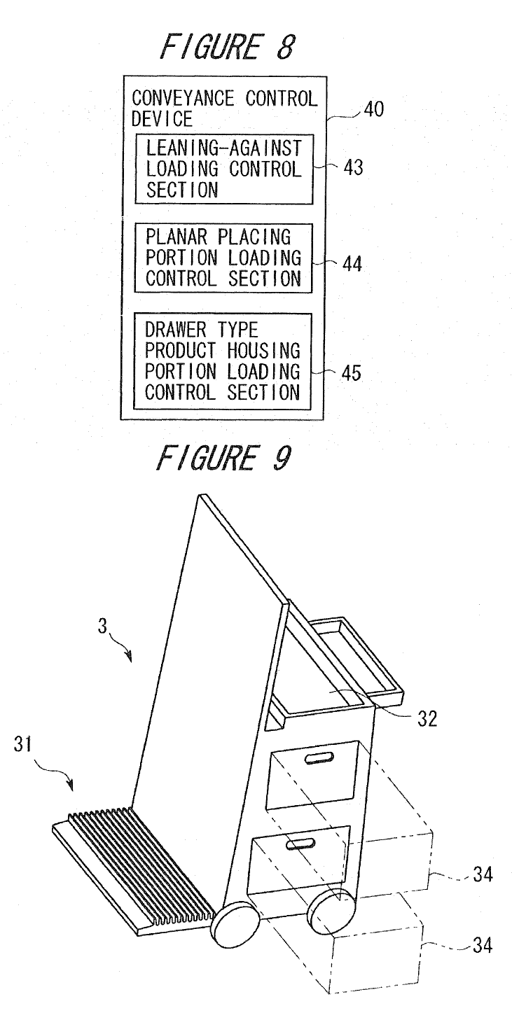

In the conveyance control device 40, the arithmetic control portion 42 and the conveyance control program 41 constitute function achieving means shown in FIG. 8. That is, the conveyance control device 40 has a leaning-against loading control section 43, a planar placing portion loading control section 44, and a drawer type product housing portion loading control section 45. The leaning-against portion loading control section 43 performs control such that the large-sized product work sheets W1 on the work sheet processing machine 1 are loaded on the leaning-against portion 31 of the work sheet collecting vehicle 3. The plate placing portion loading control section 44 performs control such that the medium-sized product work sheets W2 on the work sheet processing machine 1 are loaded on the planar placing portion 32 of the work sheet collecting vehicle 3. The drawer type product housing portion loading control section 45 performs control such that the small-sized product work sheets W3 on the work sheet processing machine 1 are loaded on the drawer type product housing portion 34 of the work sheet collecting vehicle 3. In addition to the control sections 43 to 45, the conveyance control device 40 has a palette loading control section that allows the particularly large-sized product work sheets W4 on the work sheet processing machine 1 to be loaded on the palettes 9 through the cooperation between the two traveling members 9. However, the description of the palette loading control section is omitted.

The conveyance control device 40 exchanges information with a work sheet processing control device 50 that controls the work sheet processing machine 1. The control sections 43, 44, 45 perform control in accordance with information from the work sheet processing control device 50. That is, when the work sheet processing machine 1 processes the large-sized product work sheet W1, the leaning-against portion control section 43 controls the work sheet carry-out device 2. When the work sheet processing machine 1 processes the medium-sized product work sheet W2, the planar placing portion control section 44 controls the work sheet carry-out device 2. When the work sheet processing machine 1 processes the small-sized product work sheet W3, the drawer type product housing portion control section 45 controls the work sheet carry-out device 2.

As shown in FIG. 7, the work sheet processing control device 50 is composed of a computerized numerical control device and a program controller, and comprises a processing program 51 and an arithmetic control section 52 that executes the processing program 51. The arithmetic control section 52 includes a central processing unit and a memory, as well as a programmable controller. The work sheet processing control device 50 performs control such that the work sheet processing machine 1 processes a set of the product work sheets W1 to W3 to be used to assemble a final product, in a predetermined order.

A specific description will be given of the control of the leaning-against portion loading control section 43 and the operation of the work sheet carry-out device 2. The leaning-against portion loading control section 43 issues an output instruction to the forward-backward movement driving source 16a and the traveling driving source 19 to cause the forward-backward movement driving source 16a and the traveling driving source 19 to move the traveling member 13 located at a home position (not shown in the drawings) to a position above the work sheet processing machine 1. The leaning-against portion loading control section 43 then issues an output instruction to the elevating and lowering driving source 25 to cause the elevating and lowering driving source 25 to lower the product holder 20. The leaning-against portion loading control section 43 then issues an output instruction to the product holder 20 to cause the product holder 20 to suck and hold the product work sheet W1 using the suction pads 22. At this time, all the suction pads 22 of the product holder 20 are used to suck and hold the product work sheet W1. The leaning-against portion loading control section 43 then issues an output instruction to the elevating and lowering driving source 25 to cause the elevating and lowering driving source 25 to elevate the product holder 20. The leaning-against portion loading control section 43 then issues an output instruction to the forward-backward movement driving source 16a and the traveling driving source 19 to cause the forward-backward movement driving source 16a and the traveling driving source 19 to move the traveling member 13 to a position above the leaning-against portion 31 of the work sheet collecting vehicle 3. The leaning-against portion loading control section 43 then issues an output instruction to the tilting driving source 28 to cause the tilting driving source 28 to tilt the product holder 20 such that the tilt angle of the product holder 20 is almost the same as that of the leaning-against surface 31b of the leaning-against portion 31 (FIG. 5). The leaning-against portion loading control section 43 then issues an output instruction to the elevating and lowering driving source 25 to cause the elevating and lowering driving source 25 to lower the product holder 20 until the lower end of the held product work sheet W1 almost contacts with the placement surface 31a of the leaning-against surface 31. The leaning-against portion loading control section 43 then issues an output instruction to the product holder 20 to cause the product holder 20 to cancel the suction and holding of the product work sheet W1 by the suction pads 22. Thus, the product work sheet W1 is loaded on the leaning-against portion 31 of the work sheet collecting vehicle 3 so as to lean against the leaning-against portion 31. Subsequently, the leaning-against portion loading control section 43 issues an output instruction to the driving sources 16a, 19, 25, 28 to return the work sheet carry-out device 22 to the original condition.

A specific description will be given of the control of the planar placing portion loading control section 44 and the operation of the work sheet carry-out device 2. The planar placing portion loading control section 44 issues an output instruction to the forward-backward movement driving source 16a and the traveling driving source 19 to cause the forward-backward movement driving source 16a and the traveling driving source 19 to move the traveling member 13 located at the home position (not shown in the drawings) to the position above the work sheet processing machine 1. The planar placing portion loading control section 44 then issues an output instruction to the elevating and lowering driving source 25 to cause the elevating and lowering driving source 25 to lower the product holder 30. The planar placing portion loading control section 44 then issues an output instruction to the product holder 20 to cause the product holder 20 to suck and hold the product work sheet W2 using the suction pads 22. At this time, a plurality (for example, two) of the suction pads 22 of the product holder 20 are used to suck and hold the product work sheets W1. The planar placing portion loading control section 44 then issues an output instruction to the elevating and lowering driving source 25 to cause the elevating and lowering driving source 25 to elevate the product holder 20. The planar placing portion loading control section 44 then issues an output instruction to the forward-backward movement driving source 16a and the traveling driving source 19 to cause the forward-backward movement driving source 16a and the traveling driving source 19 to move the traveling member 13 to a position above the planar placing portion 32 of the work sheet collecting vehicle 3. The planar placing portion loading control section 44 then issues an output instruction to the elevating and lowering driving source 25 to cause the elevating and lowering driving source 25 to lower the product holder 20. The planar placing portion loading control section 44 then issues an output instruction to the product holder 20 to cause the product holder 20 to cancel the suction and holding of the product work sheet W2 by the suction pads 22. Thus, the product work sheet W2 is loaded horizontally on the planar placing portion 32 of the work sheet collecting vehicle 3. Subsequently, the planar placing portion loading control section 44 issues an output instruction to the driving sources 16a, 19, 25, 28 to return the work sheet carry-out device 22 to the original condition.

A specific description will be given of the control of the drawer type product housing portion loading control section 45 and the operation of the work sheet carry-out device 2. The drawer type product housing portion loading control section 45 issues an output instruction to the forward-backward movement driving source 16a and the traveling driving source 19 to cause the forward-backward movement driving source 16a and the traveling driving source 19 to move the traveling member 13 located at the home position (not shown in the drawings) to the position above the work sheet processing machine 1. The drawer type product housing portion loading control section 45 then issues an output instruction to the elevating and lowering driving source 25 to cause the elevating and lowering driving source 25 to lower the product holder 20. The drawer type product housing portion loading control section 45 then issues an output instruction to the product holder 20 to cause the product holder 20 to suck and hold the product work sheet W3 using the suction pad 22. At this time, one of the suction pads 22 of the product holder 20 is used to suck and hold the product work sheets W3. The drawer type product housing portion loading control section 45 then issues an output instruction to the elevating and lowering driving source 25 to cause the elevating and lowering driving source 25 to elevate the product holder 20. The drawer type product housing portion loading control section 45 issues an output instruction to the forward-backward movement driving source 16a and the traveling driving source 19 to cause the forward-backward movement driving source 16a and the traveling driving source 19 to move the traveling member 13 to a position above the drawer type product housing portion 34 of the work sheet collecting vehicle 3. The drawer type product housing portion loading control section 45 then issues an output instruction to the elevating and lowering driving source 25 to cause the elevating and lowering driving source 25 to lower the product holder 20. The drawer type product housing portion loading control section 45 issues an output instruction to the product holder 20 to cause the product holder 20 to cancel the suction and holding of the product work sheet W3 by the suction pads 22. Thus, the product work sheet W3 is dropped into the drawer type product housing portion 33 of the work sheet collecting vehicle 3. Subsequently, the drawer type product housing portion loading control section 45 issues an output instruction to the driving sources 16a, 19, 25, 28 to return the work sheet carry-out device 22 to the original condition. In the present embodiment, the operations of drawing out and returning the drawer type product housing portion 34 are manually performed.

The control sections 43, 44, 45 perform control such that the work sheet carry-out device 2 performs the above-described operations. Thus, the set of product work sheets W1 to W3 processed by the work sheet processing machine 1 are sorted and loaded on the leaning-against portion 31, the planar placing portion 32, and the drawer type product housing portion 34. The order in which the work sheet processing machine 1 processes the product work sheets W1 to W3 is not particularly limited. However, product work sheets W1 to W3 used earlier during a subsequent process are desirably processed later. Processing in this order allows the product work sheets W1 to W3 to be loaded on the leaning-against portion 31, planar placing portion 32, and drawer type product housing portion 34 of the work sheet collecting vehicle 3 so that product work sheets W1 to W3 used earlier during the subsequent process are located higher on these portions. This allows any of the product work sheets W1 to w3 to be easily taken out during the subsequent process.

According to this work sheet processing system, the product work sheets W1 to W3 are sorted and loaded on the leaning-against portion 31, planar placing portion 32, and drawer type product housing portion 34 of the work sheet collecting vehicle 3 according to the type of each product work sheet. The plural types of product work sheets W1 to W3 can thus be compactly loaded. The large-sized product work sheets W1 are loaded on the leaning-against portion 31b so as to lean against the leaning-against portion 31b. This enables a reduction in the front-back length of the work sheet collecting vehicle 3 with the product work sheets W1 loaded thereon. The work sheet collecting vehicle 3 can thus easily transport the product work sheets W1 to W3 to the next process. Furthermore, when the product work sheets W1 are loaded on the leaning-against portion 31 so as to lean against the leaning against portion 31, any of the plurality of product work sheets W1 can be easily taken out even though the product work sheets W1 are large in size. In particular, in the present embodiment, the grooves 35 are formed in the work sheet placement surface 31b of the leaning-against portion 31 to create a gap between the product work sheets W1. This further facilitates the operation of taking out any of the product work sheets. Thus, even if product work sheets W1 to be used earlier during the subsequent process are loaded earlier for convenience of processing by the work sheet processing machine 1 or the like, the product work sheets W1 loaded earlier can be easily taken out. Moreover, the set of the product work sheets W1 to W3 to be used to assemble the final product are loaded on the one work sheet collecting vehicle 3. This eliminates the need for the time and effort to sort the product work sheets W1 to W3 during the subsequent process. This improves the efficiency of processing or assembly in the subsequent process. Moreover, in addition to the leaning-against portion 31, the planar placing portion 32 and the drawer type product housing portion 34 are provided to allow many types of product work sheets W1 to W3 to be sorted and loaded. In particular, the small-sized product work sheets W3 can be loaded without being distributed, by housing the product work sheets W3 in the drawer type product housing portion 34.

In the present embodiment, the operations of drawing out and returning the drawer type product housing portion 34 are manually performed. However, these operations may be performed utilizing the product holder 20 of the work sheet carry-out device 2. For example, a hook-like member may be provided on the pad support frame 21 of the product holder 20. The hook-like member can be hooked in the hand placing hole 34a in the drawer type product housing portion 34 to draw out the drawer type product housing portion 34. Alternatively, the pad support frame 21 can be used to push and return the drawer type product housing portion 34. When the work sheet carry-out device 2 performs the operations of drawing out and returning the drawer type product housing portion 34, the operator's burden is reduced, allowing the product work sheets to be efficiently carried out.

The work sheet collecting vehicle 3 according to the above-described embodiment has the only one drawer type product housing portion 34. However, the work sheet collecting vehicle 3 may have two drawer type product housing portions 34 as shown in FIG. 9 or may have at least three drawer type product housing portions 34. Providing a plurality of the drawer type product housing portions 34 allows more types of product work sheets to be sorted and loaded. Furthermore, the drawer type product housing portion 34 may be configured to be drawn out in the front-back direction. Additionally, in the present embodiment, the two traveling members 13 are provided. However, the single traveling member 13 or at least three traveling members 13 may be provided.

While the present invention has been described with respect to preferred embodiments thereof, it will be apparent to those skilled in the art that the disclosed invention may be modified in numerous ways and may assume many embodiments other than those specifically set out and described above. Accordingly, it is intented by the appended claims to cover all modifications of the present invention that fall within the true spirit and scope of the invention.

1. A work sheet processing system characterized by comprising:
a work sheet processing machine that cuts a plurality of product work sheets from a material work sheet;
a work sheet collecting vehicle on which the product work sheets cut by the work sheet processing machine are loaded; and
a work sheet carry-out device that carries out the product work sheets from said work sheet processing machine to said work sheet collecting vehicle,
said work sheet collecting vehicle having:
a planar placing portion on which said product work sheets are loaded so as to be laid on top of one another like a stack; and
a leaning-against portion on which said product work sheets are loaded so as to lean against said leaning-against portion,
said work sheet carry-out device having:
a traveling member that is travelable along a predetermined track:
a product holder which is provided on the traveling member and which can hold said product work sheets;
a tilting mechanism that can tilt said product holder according to an angle of the leaning-against portion of said work sheet collecting vehicle; and
a conveyance control device that controls said traveling member, said product holder, and said tilting mechanism such that said product work sheets on said work sheet processing machine are sorted and loaded on the planar placing portion or leaning-against portion of said work sheet collecting vehicle according to type of said product work sheets.

2. A work sheet processing system according to claim 1, characterized in that said work sheet processing machine processes a set of product work sheets used to assemble a final product, and said set of product work sheets is loaded on said work sheet collecting vehicle.

3. A work sheet processing system according to claim 1, characterized in that said work sheet collecting vehicle has a drawer type product housing portion that can be moved in and out between a storage position where the product housing portion is stored inside the work sheet collecting vehicle and a draw-out position where said product housing portion is drawn out from said work sheet collecting vehicle, and
said work sheet carry-out device performs an operation of housing said product work sheets in the drawer type product housing portion located at said draw-out position.
